(19) United States
(12) Patent Application Publication
(10) Pub. No.: US 2007/0261748 A1
(43) Pub. Date: Nov. 15, 2007

(54) Replaceable faucet assembly

(76) Inventor: Cheng Tsang Yin, Changhua (TW)

Correspondence Address: CHENG TSANG YIN, P.O. BOX 2103, TAICHUNG, omitted

(21) Appl. No.: 11/643,847

(22) Filed: Dec. 22, 2006

(30) Foreign Application Priority Data
May 12, 2006 (TW) 095208205

(51) Int. Cl. E03C 1/04; B67D 5/37

(52) U.S. Cl. 137/801

(57) ABSTRACT

A faucet assembly includes a base having a cold water pipe, a cold water valve, a hot water pipe, a hot water valve and a mixing portion. The base includes a first connection part is connected to the mixing portion, and a second connection part. A faucet includes a cold water controlling member, a hot water controlling member, an inlet, an outlet, a third connection part and a fourth connection part. The cold water controlling member controls the cold water valve and the hot water controlling member controls the hot water valve. The third connection part is located close to the inlet and removably connected to the first connection part. The fourth connection part is removably connected to the second connection part.

### FIELD OF THE INVENTION

The present invention relates to a part replaceable faucet assembly wherein each part can be easily replaceable by users.

### BACKGROUND OF THE INVENTION

A conventional faucet assembly generally includes valve portion and faucet portion which includes handles for controlling hot water valve and cold water valve. The conventional faucet assembly is made as one piece when customers purchased so that most of the parts of the conventional faucet assembly cannot be not replaced conveniently by the users. The style and color of the faucet assembly are not changeable. However, in order to match with the interior design needs, the style and/or colors of the faucet assembly may need to be changed, and the conventional faucet assembly obviously cannot meet the requirement.

The present invention intends to provide a part replaceable faucet assembly wherein the faucet and the handles can be easily replaced with different style and color ones.

### SUMMARY OF THE INVENTION

The present invention relates to a faucet assembly which comprises a base having a cold water pipe, a cold water valve, a hot water pipe, a hot water valve and a mixing portion. The cold water valve controls cold water entering into the mixing portion via the cold water pipe. The hot water valve controls hot water entering into the mixing portion via the hot water pipe. The base has a first connection part connected to the mixing portion and a second connection part. A faucet has a casing, a cold water controlling member, a hot water controlling member, an inlet, an outlet, a third connection part and a fourth connection part. The cold water controlling member controls the cold water valve and the hot water controlling member controls the hot water valve. The third connection part is located close to the inlet and removably connected to the first connection part. The fourth connection part is removably connected to the second connection part.

The primary object of the present invention is to provide a faucet assembly wherein the faucet can be conveniently replaced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the part replaceable faucet assembly of the present invention;

FIG. 2 shows the parts of the part replaceable faucet assembly of the present invention;

FIG. 3 is an exploded view to show the connection of the first and third connection parts;

FIG. 4 is a cross section of the connection of the first and third connection parts;

FIG. 5 shows that the second and fourth connection parts are connected to each other;

FIG. 6 shows another way of the connection of the second and fourth connection parts;

FIG. 7 shows a second embodiment of the part replaceable faucet assembly of the present invention;

FIG. 8 shows that either one of two faucets can be connected to the base, and

FIG. 9 shows another way of the connection between the first and third connection parts.

### DETAILED DESCRIPTION OF THE PREFERRED EMBODIMENT

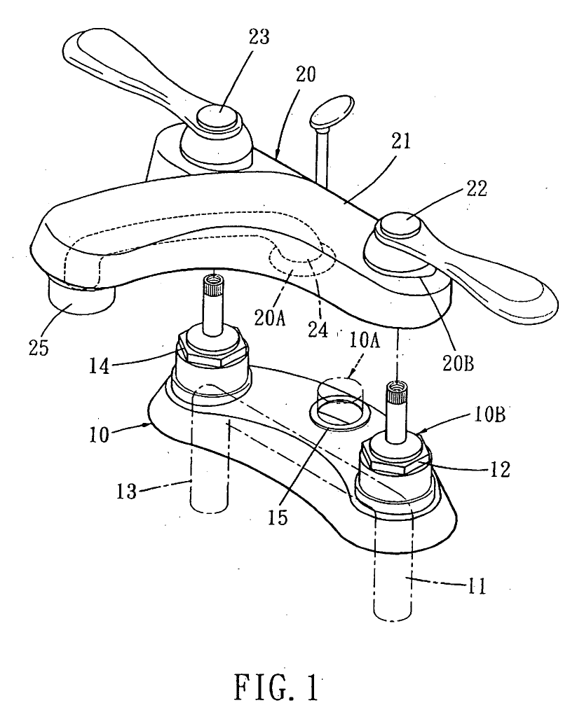

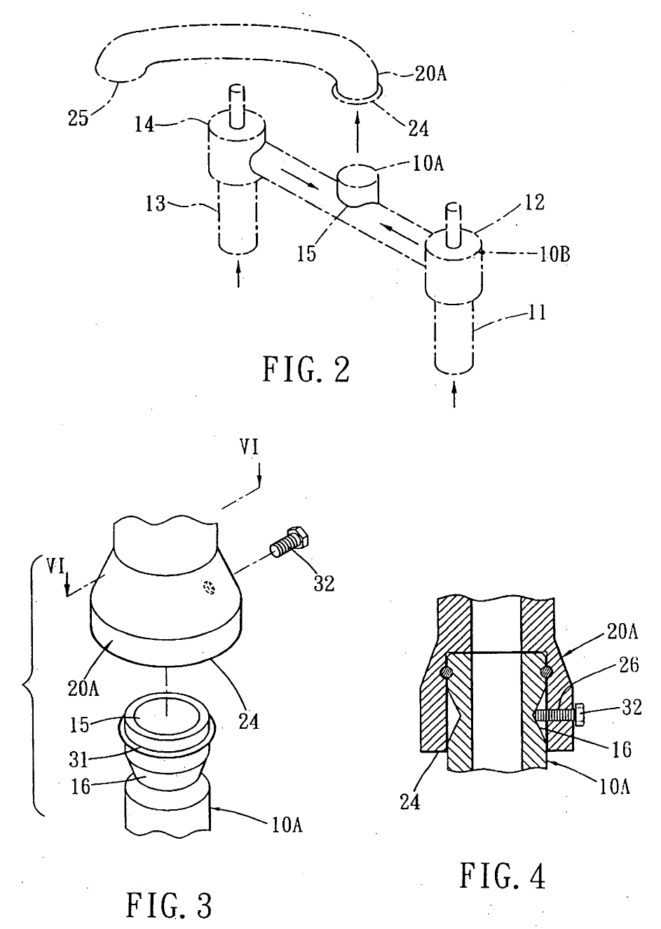

Referring to FIGS. 1 and 2, the part replaceable faucet assembly of the present invention comprises a base 10 having a cold water pipe 11, a cold water valve 12, a hot water pipe 13, a hot water valve 14 and a mixing portion 15. The cold water valve 12 controls volume of cold water entering into the mixing portion 15 via the cold water pipe 11, and the hot water valve 14 controls volume of hot water entering into the mixing portion 15 via the hot water pipe 13. The base 10 has a first connection part 10A connected to the mixing portion 15 and two second connection parts 10B which are located corresponding to the cold water valve 12 and the hot water valve 14.

A faucet 20 has a casing 21, a cold water controlling member 22, a hot water controlling member 23, an inlet 24, an outlet 25, a third connection part 20A and two fourth connection parts 20B. The cold water controlling member 22 controls the cold water valve 12 and the hot water controlling member 23 controls the hot water valve 14. The third connection part 20A is located close to the inlet 24 and removably connected to the first connection part 10A. The fourth connection parts 20B are removably connected to the second connection parts 10B. The faucet 20 can be easily and conveniently removed from the base 10 by the users.

As shown in FIGS. 3 and 4, a second embodiment of the present invention is displayed, wherein a seal member 31 and a locking member 32 are located between the first connection part 10A and the third connection part 20A. The third connection part 20A includes a hole 26 for receiving the locking member 32. The first connection part 10A has an inclined surface 16 and the locking member 32 contacts against the inclined surface 16 so as to connect the first connection part 10A and the third connection part 20A.

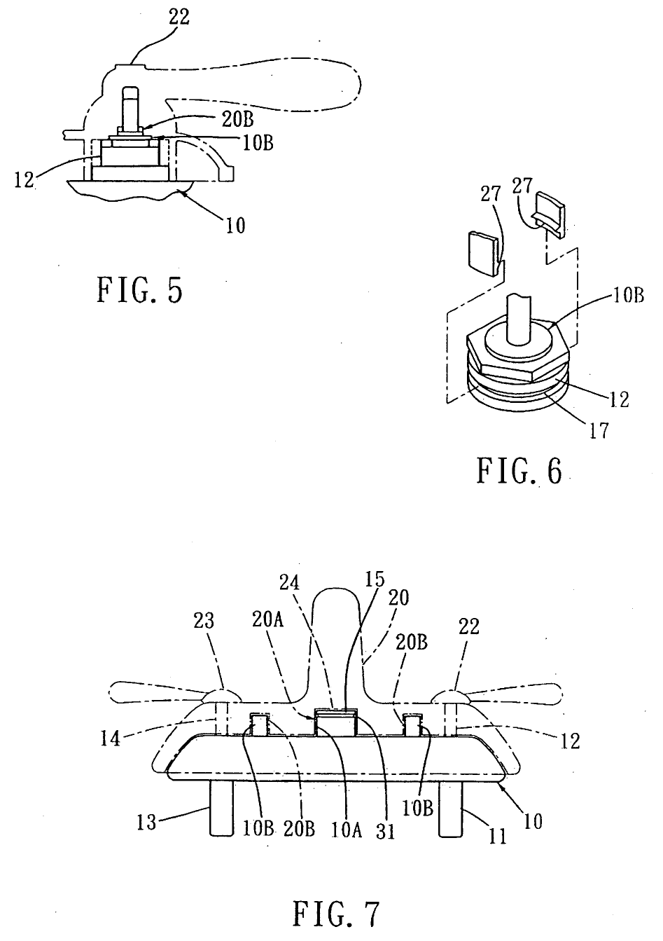

FIG. 5 shows a third embodiment of the present invention, wherein the second connection parts 10B and the fourth connection parts 20B are securely connected to each other, such as by way of force fitted.

FIG. 6 shows a fourth embodiment of the present invention, wherein each of the second connection parts 10B has a recess 17 defined in an outer surface thereof and each of the fourth connection parts 20B has two engaging members 27 which are engaged with the recess 17 to combine the second connection parts 10B and the fourth connection parts 20B.

FIG. 7 shows a fifth embodiment of the present invention, wherein each of the second connection parts 10B is a protrusion and each of the fourth connection parts 20B has a notch with which the protrusion corresponding thereto is engaged so as to combine the second connection parts 10B and the fourth connection parts 20B.

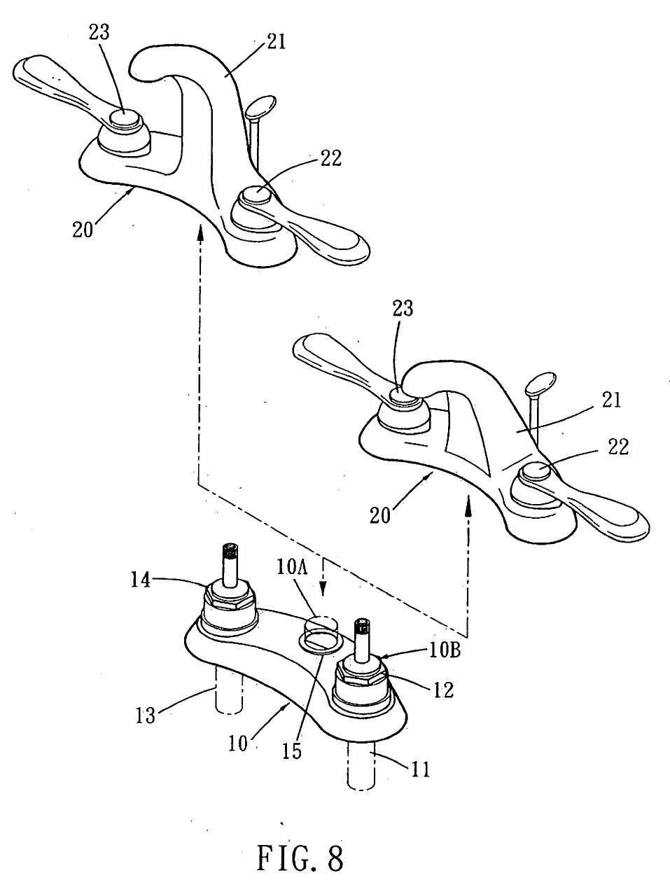

As disclosed in FIG. 8, the base 10 with the first connection part 10A and the two second connection parts 10B can be connected with different faucets 20 of different styles or colors. The users can easily remove the previous faucet 20 and replaced it with another faucet 20.

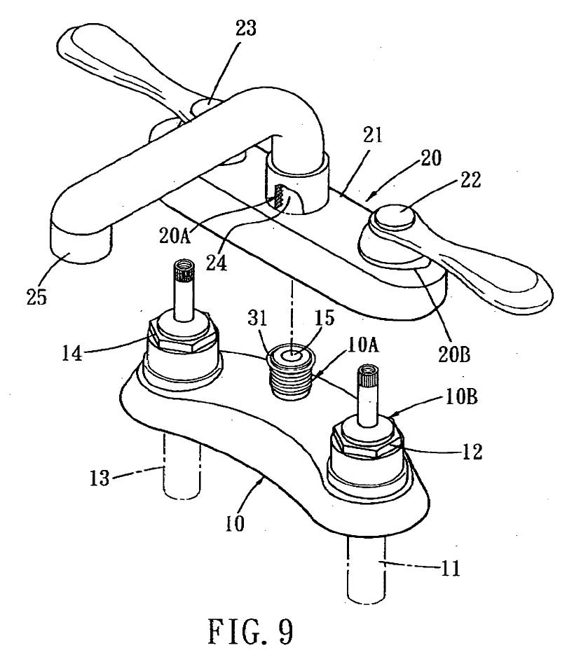

FIG. 9 shows a sixth embodiment of the present invention, wherein the first connection part 10A has an outer threaded periphery and the third connection part 20A has an inner threaded periphery which is engaged with the outer threaded periphery of the first connection part 10A. The same way can also be used for the connection between the second connection parts 10B and the fourth connection part 20B. A seal member 31 is used for each connection to prevent from leakage.

By the faucet assembly, the users can change the faucet 20 as needed without too much of efforts or professional skills.

While we have shown and described the embodiment in accordance with the present invention, it should be clear to those skilled in the art that further embodiments may be made without departing from the scope of the present invention.

What is claimed is:

1. A faucet assembly comprising:
a base having a cold water pipe, a cold water valve, a hot water pipe, a hot water valve and a mixing portion, the cold water valve controlling cold water entering into the mixing portion via the cold water pipe, the hot water valve controlling hot water entering into the mixing portion via the hot water pipe, the base having a first connection part connected to the mixing portion and a second connection part, and
a faucet having a casing, a cold water controlling member, a hot water controlling member, an inlet, an outlet, a third connection part and a fourth connection part, the cold water controlling member controlling the cold water valve, the hot water controlling member controlling the hot water valve, the third connection part located close to the inlet and removably connected to the first connection part, the fourth connection part removably connected to the second connection part.

2. The assembly as claimed in claim 1, wherein a seal member and a locking member are located between the first connection part and the third connection part, the third connection part includes a hole for receiving the locking member, the first connection part has an inclined surface and the locking member contacts against the inclined surface so as to connect the first connection part and the third connection part.

3. The assembly as claimed in claim 1, wherein the second connection part and the fourth connection part are securely connected to each other.

4. The assembly as claimed in claim 1, wherein the second connection part has a recess defined in an outer surface thereof and the fourth connection part has an engaging member which is engaged with the recess to combine the second connection part and the fourth connection part.

5. The assembly as claimed in claim 1, wherein the second connection part is a protrusion and the fourth connection part has a notch with which the protrusion is engaged so as to combine the second connection part and the fourth connection part.
